(19) United States
(12) Patent Application Publication
(10) Pub. No.: US 2011/0082943 A1
(43) Pub. Date: Apr. 7, 2011

(54) P2P NETWORK SYSTEM AND DATA TRANSMITTING AND RECEIVING METHOD THEREOF

(75) Inventors: Ho-jin HA, Suwon-si (KR); O-hoon KWON, Suwon-si (KR); Sung-Bin IM, Yongin-si (KR)

(73) Assignee: SAMSUNG ELECTRONICS CO., LTD., Suwon-si (KR)

(21) Appl. No.: 12/731,619

(22) Filed: Mar. 25, 2010

(30) Foreign Application Priority Data
Oct. 7, 2009 (KR) 10-2009-0095093

(51) Int. Cl. G06F 15/16

(52) U.S. Cl. 709/231

(57) ABSTRACT

A peer-to-peer (P2P) network system is provided. The P2P network system includes a server which groups transmission unit packets constituting a data stream into a group according to a predetermined time unit and provides the group of the transmission unit packets, and a plurality of peer devices which transmit and receive the group of the transmission unit packets.

### CROSS-REFERENCE TO RELATED APPLICATIONS

This application claims priority from Korean Patent Application No. 10-2009-0095093, filed on Oct. 7, 2009, in the Korean Intellectual Property Office, the disclosure of which is incorporated herein by reference in its entirety.

### BACKGROUND

1. Field

Methods and apparatuses of the exemplary embodiments relate to a peer-to-peer (P2P) network system and a data transmitting and receiving method thereof, and more particularly, to a P2P network system which groups data in a time unit and transmits the data, and a data transmitting and receiving method thereof.

2. Description of the Related Art

The term “streaming” refers to a technique that transmits, receives, and decodes multimedia data such as video and audio data on a real time basis, thereby optimally using a network and a central processing unit (CPU) resource, and continuously processes transmitted data without intermission. The streaming technique becomes more important with the growth of the Internet because a demand for a high speed access line which is sufficient to download multimedia files promptly is still not met.

A general method for a receiving side to download entire contents and then receive a service requires a long standby time, whereas the streaming technique allows a client browser or a plug-in to represent data even before all contents are downloaded. Such a streaming service has the advantage that a user can receive a service for contents promptly.

If a server-client method is employed in the streaming service, many clients may access the server simultaneously, and thus, a server suffers from insufficient bandwidth or insufficient CPU performance. Therefore, the server has difficulty in providing the streaming service smoothly. In order to use bandwidth efficiently, a multicast method or a P2P method are increasingly used.

The P2P method allows peers to share a file and does not discriminate between a server and a client. That is, in the P2P method, each peer may serve as a transmitter or a receiver depending on a situation. The P2P method has the advantages that a load does not increase at a specific server and several peers over a network are used so that throughput can be improved

In the P2P method, a file is transmitted and received between the peers in a unit of data which is divided by a predetermined size. In this case, however, there is a problem that it is difficult to map time information to specific data.

Also, there is a problem that unnecessary data is buffered since time information is not used.

### SUMMARY

Exemplary embodiments overcome the above disadvantages and other disadvantages not described above. Also, the exemplary embodiments are not required to overcome the disadvantages described above, and an exemplary embodiment may not overcome any of the problems described above.

One or more exemplary embodiments provide a peer-to-peer (P2P) network system which groups a data stream in a time unit and transmits and receives the data stream, and a data transmitting and receiving method thereof
According to an aspect of the exemplary embodiments, a P2P network system includes: a server which groups transmission unit packets constituting a data stream into a group according to a predetermined time unit and provides the group of the transmission unit packets, and a plurality of peer devices which transmit and receive the group of the transmission unit packets.

The server may include: a source providing unit which provides the data stream, a data constitution unit which receives the data stream from the source providing unit and groups the transmission unit packets constituting the data stream into the group according to the predetermined time unit, and a data transmission and reception unit which transmits the group of the transmission unit packets.

The data constitution unit may group the transmission unit packets using time information included in the data stream.

The time information may be presentation time stamp (PTS) information.

Each group may include at least one piece of PTS information.

According to another aspect of the exemplary embodiments, a server of a P2P network system, includes: a source providing unit which provides a data stream; a data constitution unit which receives the data stream from the source providing unit and groups transmission unit packets constituting the data stream in a group according to a predetermined time unit, and a data transmission and reception unit which transmits the group of the transmission unit packets.

The data constitution unit may group the transmission unit packets using time information included in the data stream.

The time information may be PTS information.

Each group may include at least one piece of PTS information.

Each group may include at least one transmission unit packet and a first transmission unit packet of each group may include PTS information.

According to still another aspect of the exemplary embodiments, a data transmitting and receiving method of a P2P network system, includes: grouping transmission unit packets constituting a data stream into a group according to a predetermined time unit and providing the groups of the transmission unit packets; and transmitting and receiving the group of the transmission unit packets.

The grouping of the transmission unit packets may include grouping the transmission unit packets using time information included in the data stream.

The time information may be PTS information.

Each group may include at least one piece of PTS information.

Each group may include at least one transmission unit packet and a first transmission unit packet of each group may include PTS information.

Accordingly, an effective P2P network system can be provided.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and/or other aspects will be more apparent by describing in detail the exemplary embodiments, with reference to the accompanying drawings in which:

FIG. 1 is a block diagram schematically illustrating a P2P network system according to an exemplary embodiment;

FIG. 2 is a block diagram illustrating the streaming server of FIG. 1 in detail;

FIGS. 3A and 3B are views illustrating a structure of an MPEG-2 data stream of the exemplary embodiments;

FIGS. 4A and 4B are views to explain a TS packet grouping method according to the exemplary embodiments;

FIG. 5 is a block diagram illustrating the information management server of FIG. 1 in detail;

FIG. 6 is a block diagram illustrating the peers of FIG. 1 in detail;

FIG. 7 is a flowchart illustrating a data transmitting and receiving method of a P2P network system according to an exemplary embodiment; and

FIG. 8 is a flowchart illustrating a data grouping method according to an exemplary embodiment.

### DETAILED DESCRIPTION OF THE EXEMPLARY EMBODIMENTS

Hereinafter, the exemplary embodiments will be described in greater detail with reference to the accompanying drawings, in which the exemplary embodiments are shown.

In the following description, like reference numerals in the drawings denote like elements. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail. Expressions such as “at least one of” when preceding a list of elements, modify the entire list of elements and do not modify the individual elements of the list.

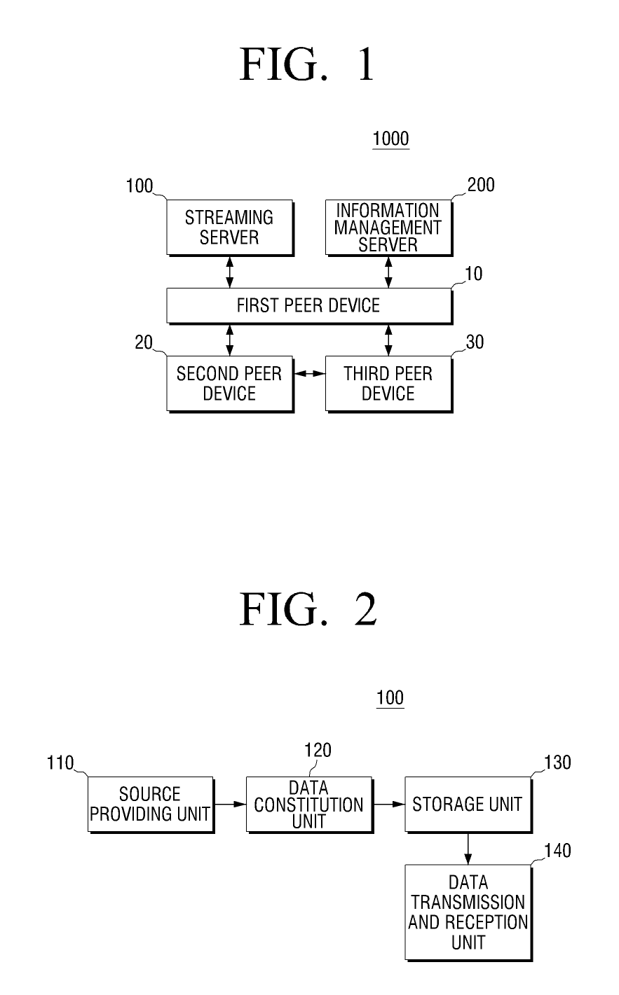

FIG. 1 is a block diagram schematically illustrating a peer-to-peer (P2P) network system according to an exemplary embodiment.

The P2P network system may be applied to a file sharing service or a streaming service. However, in this exemplary embodiment, the P2P network system is limited to a streaming service for convenience of explanation.

Referring to FIG. 1, the P2P network system 1000 includes a streaming server 100, an information management server 200, and a plurality of peer devices 10 to 30.

The streaming server 100 transmits a data stream comprising multimedia contents (hereinafter, referred to as a “data stream”) to at least one of the plurality of peer devices connected to one another through a network.

The streaming server 100 may be realized as an interface which transmits a data stream, which has been received from a source provider (not shown) connected thereto through a network, to at least one of the plurality of peer devices. Also, the streaming server 100 may include a separate data base and may be designed to transmit a pre-stored data stream.

More specifically, the streaming server 100 groups transmission unit packets of a data stream with reference to time information, and transmits the data stream to the peer device which has access to the P2P network system.

The data transmission is performed between the first peer device 10, which first requests the streaming server 100 to provide a streaming service, and other peer devices (second and third peer devices 20, 30), to transmit in units of packets the transmission unit packets which are grouped with reference to time information.

When data is to be transmitted according to a moving picture expert group (MPEG)-2 standard, transport stream (TS) packets, which are the transmission unit packets, are grouped based on presentation time stamp (PTS) information included in a MPEG-2 stream, and the data is transmitted in units of grouped TS packets. This will be explained below in detail with reference to the drawings.

The streaming server 100 may be realized as a web server which provides a streaming service.

If there is a plurality of peer devices which request the streaming server 100 to provide a streaming service for the same multimedia contents, the information management server 200 generates a list of corresponding peer devices and provides the list to the corresponding peer devices.

The information management server 200 periodically manages the list of peer devices if a pre-set event occurs.

For example, if there is a change in the number of peer devices which receive access to the same content, if a new peer device receives access to the same content, or if a peer device is disconnected from the contents, the information management server 200 may periodically update the list of peer devices and provide an updated list to the peer devices. Accordingly, the list of peer devices includes information with respect to which peer devices have access to which content.

The information management server 200 may be provided separately from the streaming server 100 or may be located within the streaming server 100.

The plurality of peer devices 10 to 30 transmit and receive data using the P2P method. The P2P method is a method for sharing a file between the peer devices and does not discriminate between a server and a client. In the P2P method, each peer device is a transmitter or a receiver depending on a situation.

The plurality of peer devices 10 to 30 transmit and receive data in group units of TS packets which are grouped with reference to the PTS information as described above.

For example, the first peer device 10, which first receives access to the streaming server 100, receives streaming data from the streaming server 100 in group units of TS packets, and reproduces the streaming data and simultaneously transmits the TS packet group units to the second peer device 20 using the P2P method.

FIG. 2 is a block diagram illustrating the streaming server of FIG. 1 in detail.

Referring to FIG. 2, the streaming server 100 includes a source providing unit 110, a data constitution unit 120, and a data transmission and reception unit 130. Each of the source providing unit 110, the data constitution unit 120, and the data transmission and reception unit 130 comprise hardware.

The source providing unit 110 may be an interface to transmit multimedia contents, which have been received from a source provider (not shown) connected through the network, to at least one of the plurality of peer devices 10 to 30.

The source providing unit 110 may have a database and provide pre-stored multimedia contents.

The data constitution unit 120 divides the data stream according to a predetermined time unit. For example, if the data stream conforms to the MPEG-2 standard, the data constitution unit 120 groups TS packets constituting the data stream according to the predetermined time unit.

Hereinafter, a method for grouping a data stream of the MPEG-2 standard in a predetermined time unit will be described in detail.

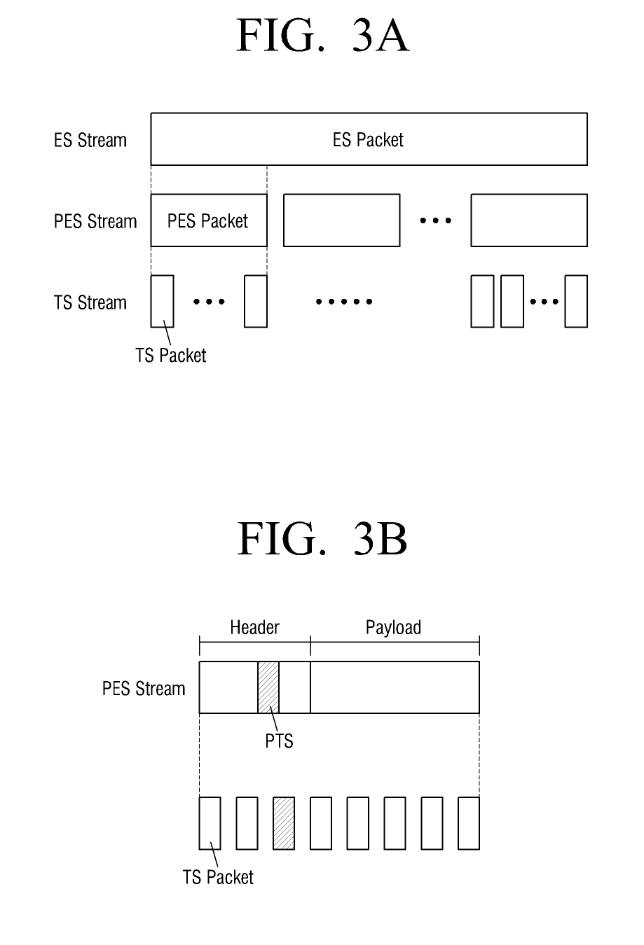

FIGS. 3A and 3B are views illustrating a structure of an MPEG-2 data stream to assist in a comprehensive understanding of the exemplary embodiments.

An elementary stream or encoding stream (ES) constituting an MPEG-2 data stream is subjected to a system encoding process such that it is reconstituted as a series of TS packets. The system encoding process refers to a process that receives and packetizes an ES to generate a packetized elementary stream (PES), and creates TS packets or packetized stream (PS) packets from the PES. This process is included in the MPEG-2 standard and thus detailed description is omitted.

As shown in FIG. 3A, the ES is encoded into a PES which consists of a series of PES packets.

The PES may consist of PES packets of the same type (e.g., Video PES, Audio PES, and Teletext PES). In this exemplary embodiment, one PES packet consists of a series of TS packets and each TS packet consists of 188 bytes.

FIG. 3B is a view illustrating the PES packet in detail.

The PES packet includes a PES header and a payload area. The payload refers to data which is obtained by dividing the ES continuously, and the header refers to an area which records information needed to add data of the payload.

More specifically, the PES header includes a start bit, a Stream_ID, a packet total length, a presentation time stamp (PTS), and a decoder time stamp (DTS). The Stream_ID indicates the type of packet (i.e., the type of payload data).

The DTS indicates a time at which a corresponding PES should be decoded, and the PTS indicates a time at which the decoded PES should be displayed.

Each TS packet which constitutes the PES packet includes a header and a payload area, and the TS header of the TS packet includes a program clock reference (PCR).

The PCR included in the TS header provides a reference time base for each time stamp (PTS and DTS), and a receiver receiving an MPEG-2 stream performs play-synchronization using PTS information and PCR information.

That is, the data constitution unit 120 groups the TS packets using the PTS information included in the header of the PES packet.

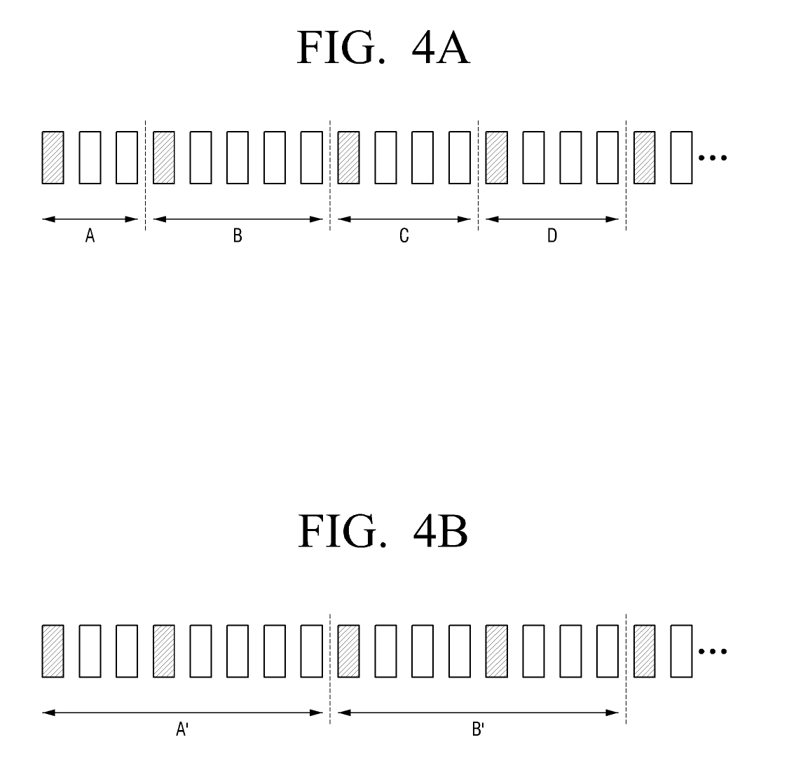

FIGS. 4A and 4B are views to explain a TS packet grouping method according to the exemplary embodiments.

In FIGS. 4A and 4B, each block represents a TS packet and a hatched block represents a TS block including a PTS.

That is, since PTS information is included in the header of each PES packet, only some of the TS packets include the PTS information.

As shown in FIG. 4A, the TS packets are grouped with reference to a TS packet including the PTS information (group A, B, . . . ) so that the data can be transmitted in units of grouped packets.

That is, in the P2P network system according to an exemplary embodiment, the data is transmitted in a plurality of units of packets, the packets being grouped into corresponding units with reference to the PTS information.

In FIG. 4A, the TS packets are grouped in a manner that the PTS information is included in once per group. However, this should not be considered as limiting. As shown in FIG. 4B, the TS packets may be grouped (group A′, B′, . . . ) in a manner that two pieces of PTS information are included in one group. Of course, three or more pieces of PTS information may be included in one group.

Also, all TS packets may be grouped according to a predetermined time unit (e.g., 0.2 sec.). The first group is grouped in a predetermined time unit and the other groups are grouped in the same time unit as in the previous group.

The storage unit 130 stores the TS packets which have been grouped by the data constitution unit 120 by group.

That is, the storage unit 130 groups a data stream which is provided from a source provider (not shown) on a real time basis in the above-described method, and stores the grouped data stream by group, or groups a data stream pre-stored in the database in the above-described method and stores the grouped data stream.

In this case, the data transmission and reception unit 140 transmits the data stored in the storage unit 130 in the group units to at least one peer device.

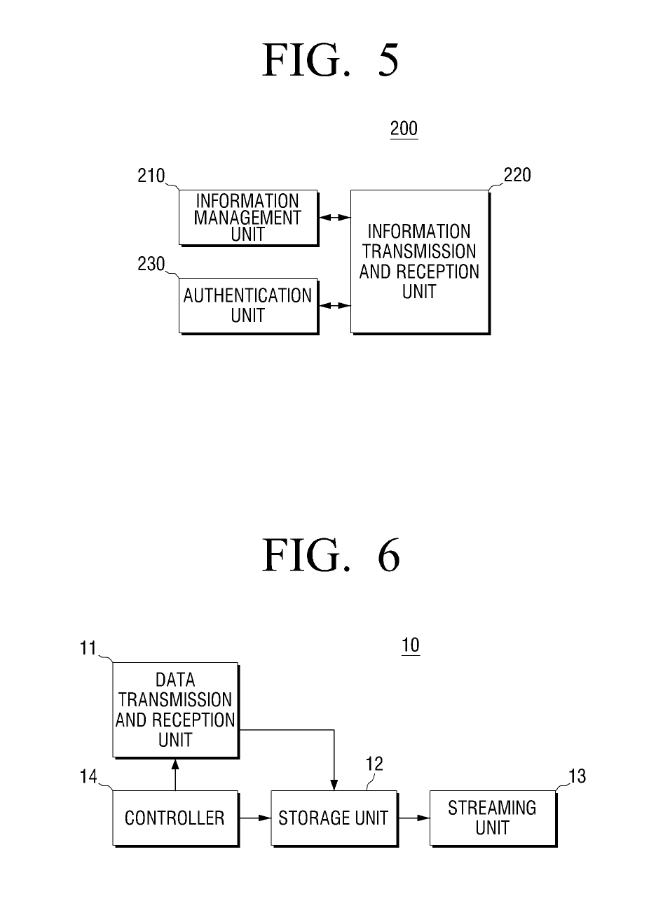

FIG. 5 is a block diagram illustrating the information management server of FIG. 1 in detail.

The information management server 200 includes an information management unit 210, an information transmission and reception unit 220, and an authentication unit 230. Each of the information management unit 210, the information transmission and reception unit 220, and the authentication unit 230 comprises hardware.

The information management unit 210 manages a list of peer devices which request the streaming server 100 to provide a service for contents.

The information management unit 210 generates a list of peer devices which request the streaming server 100 to provide a service for the same content, and transmits the list to the information transmission and reception unit 220.

For example, if peer devices ‘a’, ‘b’, and ‘c’ request a service for ‘content 1’ and peer devices ‘d’, ‘e’, and ‘f’ request a service for ‘content 2’, lists 1 and 2 are created by the information management unit 210 for the content 1 and the content 2, respectively.

Also, if a new peer device receives access to a content or if a peer device is disconnected from a content, the information management unit 210 updates the list of peer devices for that content.

The information transmission and reception unit 220 transmits the list of peer devices created or updated by the information management unit 210 to the corresponding peer devices. For example, the list 1 for the ‘content 1’ is transmitted to the corresponding peer devices ‘a’, ‘b’, and ‘c’.

The authentication unit 230 authenticates the peer devices which request the streaming server 100 to provide a service for contents.

FIG. 6 is a block diagram illustrating the peer devices 10 to 30 of FIG. 1 in detail. For convenience of explanation, only the peer 10 is illustrated.

Referring to FIG. 6, the peer 10 includes a data transmission and reception unit 11, a storage unit 12, a streaming unit 13, and a controller 14. Each of the data transmission and reception unit 11, the storage unit 12, the streaming unit 13, and the controller 14 comprise hardware.

The data transmission and reception unit 11 may include a first transmission and reception unit to receive data from the streaming server 100 or the other peer devices and to transmit the data to the other peer devices, and a second transmission and reception unit to receive the list of peer devices and its related information from the information management server 200. Since the configuration of the exemplary embodiment in which the data transmission and reception unit 11 includes the first and the second transmission and reception units, the data transmission and reception unit 11 is explained as incorporating the functions of the first and the second transmission and reception units hereinafter.

The data transmission and reception unit 11 receives a list of peer devices which concurrently have access to the content requested by the peer device 10 from the information management server 200.

The data transmission and reception unit 100 may transmit data group information (i.e., TS packet group information described above) of its own to the other peer devices 20, 30 which concurrently have access to the corresponding content, by referring to the list of peer devices received from the information management server 200. The other peer devices 20, request the peer device 10 to provide a necessary data group using the data group information.

Also, the data transmission and reception unit 11 of peer device 10 transmits a data group which is requested by the other peer devices 20, to the other peer devices 20, 30.

The storage unit 12 of peer device 10 stores data received from the streaming server 100 or other peer devices 20, 30. The storage unit 12 may be realized as a streaming buffer and may store a currently streaming data group and a data group of a time slot after or before a predetermined time according to its capacity.

The streaming unit 13 reproduces the data group stored in the storage unit 12.

The controller 14 controls overall operation of the peer device 10.

More specifically, if there is a request for data transmission through the data transmission and reception unit 11, the controller 14 controls the data group stored in the storage unit 12 to be transmitted to a corresponding peer device.

Also, the controller 14 controls deleting/adding a data group from/to the data group stored in the storage unit 12.

The peer device 10 may further include a display unit (not shown) to display the data reproduced by the streaming unit 13.

Although the peer 10 device is described in the above, the peer devices 20, 30 operate in the same way as the peer device 10.

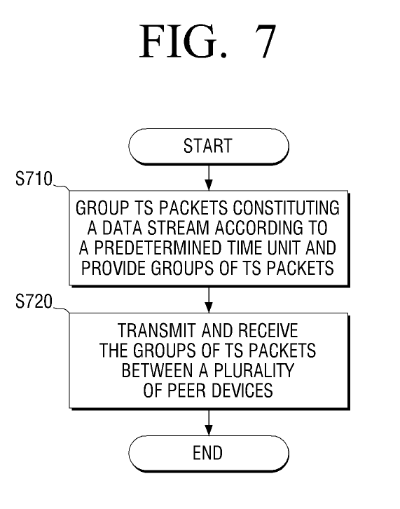

FIG. 7 is a flowchart illustrating a data transmitting and receiving method of a P2P network system according to an exemplary embodiment.

According to the data transmitting and receiving method shown in FIG. 7, a server groups TS packets constituting a data stream according to a predetermined time unit and provides the grouped TS packets in groups (S710). The server may be a server which provides a streaming service or a server which provides a file sharing service.

Then, a plurality of peer devices transmit and receive the TS packets which are grouped according to the predetermined time unit as group units (S720).

The TS packet refers to a transmission unit packet according to the MPEG-2 standard and was described above in detail Thus, the detailed description of TS packets is omitted.

In operation S710, packets of a data stream may be grouped using time information included in the data stream.

In the case of MPEG-2 standard, the time information may be presentation time stamp (PTS) information.

The PTS information is included in the header area of each PES packet and indicates a time at which a corresponding PES packet should be displayed after being decoded.

That is, in operation S710, the TS packets are grouped using the PTS information included in the header of the PES packet. The TS packet refers to a transmission unit packet that constitutes the PES packet.

In this case, since each group is grouped with reference to the PTS information in operation S710, each group includes at least one piece of PTS information.

Each group may include two or more pieces of PTS information. In this case, each group includes the same number of pieces of PTS information.

More specifically, since each group is grouped with reference to the PTS information in operation S710, the first TS packet of each group includes the PTS information.

In operation S720, each peer device, which communicates in the P2P method, transmits and receives data in each group unit which is grouped in operation S710.

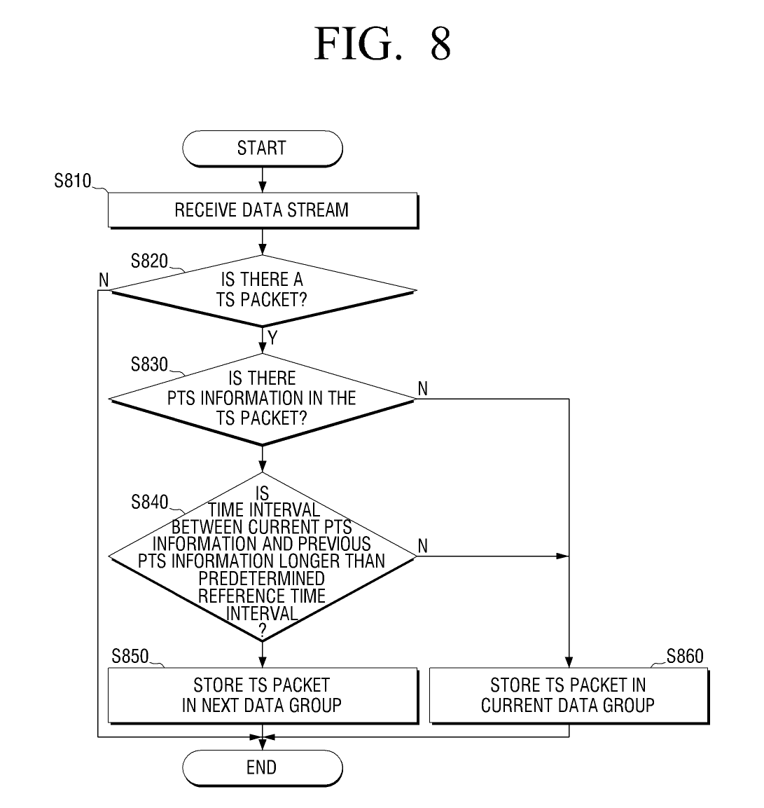

FIG. 8 is a flowchart illustrating a data grouping method according to an exemplary embodiment.

According to the data grouping method of FIG. 8, if a data stream is received (S810), it is determined whether there is a TS packet in the data stream or not (S820).

If it is determined that there is a TS packet in the data stream (S820: Y), it is determined whether the corresponding TS packet includes PTS information or not (S830).

If it is determined that the TS packet includes PTS information (S830: Y), it is determined whether or not a time interval between a currently detected PTS information and a previously detected PTS information is longer than a predetermined reference time interval which is a reference for grouping TS packets (S840).

If it is determined that the time interval between the currently detected PTS information and the previously detected PTS information is longer than the predetermined reference time interval (S840: Y), the corresponding TS packet is grouped into a next data group and stored (S850).

If it is determined that the time interval between the currently detected PTS information and the previously detected PTS information is shorter than or equal to the predetermined reference time interval (S840: N), the corresponding TS packet is grouped into a current data group and stored (S860).

The TS packets which are grouped and stored as described above are transmitted between the peer devices in group units.

Accordingly, by mapping the time information and the data information, data are easily applied to a real-time streaming protocol (RTSP).

Also, there are advantages that data can be managed as much as necessary, and unnecessary data should not be buffered.

Also, a seek latency for data can be reduced.

The foregoing exemplary embodiments and advantages are merely exemplary and are not to be construed as limiting. The present teaching can be readily applied to other types of apparatuses. Also, the description of the exemplary embodiments are intended to be illustrative, and not to limit the scope of the claims, and many alternatives, modifications, and variations will be apparent to those skilled in the art.

What is claimed is:

1. A peer-to-peer (P2P) network system comprising:
a server which groups transmission unit packets of a data stream into a group according to a predetermined time unit and provides the group of the transmission unit packets; and
a plurality of peer devices which receive and transmit the group of the transmission unit packets.

2. The P2P network system as claimed in claim 1, wherein the server comprises:
a source providing unit which provides the data stream;
a data constitution unit which receives the data stream from the source providing unit and groups the transmission unit packets of the data stream into the group according to the predetermined time unit; and
a data transmission and reception unit which transmits the group of the transmission unit packets.

3. The P2P network system as claimed in claim 2, wherein the data constitution unit groups the transmission unit packets using time information included in the data stream.

4. The P2P network system as claimed in claim 3, wherein the time information is presentation time stamp (PTS) information.

5. The P2P network system as claimed in claim 4, wherein the group includes at least one piece of PTS information.

6. A server of a P2P network system, comprising:
a source providing unit which provides a data stream;
a data constitution unit which receives the data stream from the source providing unit and groups transmission unit packets of the data stream in a group according to a predetermined time unit; and
a data transmission and reception unit which transmits the group of the transmission unit packets.

7. The server as claimed in claim 6, wherein the data constitution unit groups the transmission unit packets using time information included in the data stream.

8. The server as claimed in claim 7, wherein the time information is presentation time stamp (PTS) information.

9. The server as claimed in claim 8, wherein the group includes at least one piece of PTS information.

10. The server as claimed in claim 9, wherein the group includes at least one transmission unit packet and a first transmission unit packet of the group includes the at least one piece of PTS information.

11. A data transmitting and receiving method of a P2P network system, the method comprising:
grouping transmission unit packets of a data stream into a group according to a predetermined time unit and providing the group of the transmission unit packets; and
transmitting and receiving the group of the transmission unit packets between a plurality of peers.

12. The method as claimed in claim 11, wherein the grouping of the transmission unit packets includes grouping the transmission unit packets using time information included in the data stream.

13. The method as claimed in claim 12, wherein the time information is presentation time stamp (PTS) information.

14. The method as claimed in claim 13, wherein the group includes at least one piece of PTS information.

15. The method as claimed in claim 14, wherein the group includes at least one transmission unit packet and a first transmission unit packet of the group includes the at least one piece of PTS information.

16. A peer-to-peer (P2P) network system comprising:
a streaming server which groups transmission unit packets of a data stream into groups according to a predetermined time unit and provides the groups of the transmission unit packets to at least one of a plurality of peer devices; and
the plurality of peer devices which transmit and receive the groups of the transmission unit packets by group,
wherein the streaming server groups the transmission unit packets into the groups using time information included in the data stream, and
the steaming server determines whether a time interval between a currently detected time information of a current transmission unit packet and a previously detected time information of a previous transmission unit packet is longer than the predetermined time unit,
if the streaming server determines that the time interval between the currently detected time information and the previously detected time information is longer than the predetermined time unit, the current transmission unit packet is grouped into a next group, and
if the streaming server determines that the time interval between the currently detected time information and the previously detected time information is shorter than or equal to the predetermined time unit, the current transmission unit packet is grouped into a current group.

17. The P2P network system as claimed in claim 16, wherein the streaming server determines whether the current transmission unit packet includes the time information, and, if the current transmission unit packet does not include the time information, the current transmission unit packet is grouped into a current group.

18. The P2P network system as claimed in claim 17, wherein the time information is presentation time stamp (PTS) information, at least one of the transmission unit packets include the PTS information, and each of the groups includes at least one piece of PTS information.

19. The P2P network system as claimed in claim 16, further comprising an information management server which generates a list of peer devices which have access to a multimedia content, and provides the list of peer devices to only each of the plurality of peer devices which have access to the multimedia content.

20. The P2P network system as claimed in claim 19, wherein the information management server updates the list of peer device upon an occurrence of a pre-set event.
